(19) United States
(12) Patent Application Publication
(10) Pub. No.: US 2004/0152379 A1
(43) Pub. Date: Aug. 5, 2004

(54) Textile reinforced wallboard

(76) Inventors: George C. McLarty III, Greenville, SC (US); Andrew D. Child, Moore, SC (US); Johan Gerlich, Paraparaumn (NZ)

Correspondence Address: Thomas L. Moses, Legal Department, M-495, P.O. Box 1926, Spartanburg, SC, 29304, US

(21) Appl. No.: 10/354,612

(22) Filed: Jan. 30, 2003

(51) Int. Cl. B32B 13/14; B32B 17/04; B32B 13/02; B32B 27/04; B32B 27/12; D04B 1/00

(52) U.S. Cl. 442/42; 442/20; 442/26; 442/33; 442/34; 442/149; 442/150; 442/180

(57) ABSTRACT

A novel gypsum wallboard having a textile reinforcing material embedded within a gypsum core together with randomly oriented chopped glass fibers, as well as a novel process for constructing such gypsum wallboards.

### FIELD OF THE INVENTION

This invention relates to a gypsum wallboard, and more specifically to a novel gypsum wallboard having a textile reinforcing material embedded within a gypsum core together with randomly oriented chopped glass fibers. This invention further includes a novel process for constructing gypsum wallboards.

### BACKGROUND OF THE INVENTION

Many past attempts have been made to strengthen gypsum wallboard by using different types of fibers in various configurations. Reinforcing fibers have been employed to strengthen the wallboard, usually by simply adding the reinforcing fibers to the core formulation. These chopped fibers tend to attach to the gypsum forming a random network within the core to prevent or reduce the amount of core fragments that might otherwise detach from the board or that may otherwise become loose. Additionally, the use of chopped glass fibers tends to increase fire resistance.

Alternatively, continuous glass fiber strands have been utilized for reinforcement purposes, as well. Such continuous fiber strands may be bonded to the cover sheets, for instance in an undulating pattern in the plane of the board, or may be incorporated in the form of a fishnet or scrim arrangement.

Throughout the evolution of building products, the trend has been to make stronger, lighter wall assemblies that are cost efficient, fire resistant, and easy to assemble. Accordingly, it would be desirable to provide a stronger gypsum wallboard that may perform better than existing wallboards in standard hard body impact, standard soft body impact, and flexural strength tests, while maintaining an acceptable level of fire resistance. Further, it would be desirable to provide a method for manufacturing such a wallboard with efficient use of materials.

### SUMMARY OF THE INVENTION

Accordingly, it is an important object of the present invention to provide a gypsum wallboard having superior strength and fire resistance characteristics to resist typical impacts and fires that may result in a building in which the panel is used.

Another important object of the present invention is to provide a method for manufacturing a gypsum wallboard having such superior strength and fire resistance characteristics.

Yet another important object of the present invention is to provide a novel wallboard, wherein one embodiment includes gypsum core having chopped glass fibers, a reinforcing scrim material adhered together by an acrylic adhesive, and an outer layer of paper on both faces of the wallboard.

Still another important object of the present invention is to provide a novel gypsum wallboard having superior strength while maintaining fire resistance characteristics, as well as a method for inexpensively manufacturing such wallboards, wherein the novel device and method overcome some of the problems commonly associated with prior wallboards and prior manufacturing techniques.

### BRIEF DESCRIPTION OF THE DRAWINGS

These and other features, aspects, and advantages of the present invention will become better understood with regard to the following description, appended claims, and accompanying drawings where:

FIG. 1 illustrates an enlarged cross-sectional view of a gypsum wallboard constructed in accordance with this invention;

FIG. 2 shows diagrammatically a production line for the continuous production of a reinforced gypsum wallboard;

FIG. 3 shows a perspective view of a three-dimensional reinforcing fabric; and

FIG. 4 shows a cross section of a gypsum wallboard incorporating the three-dimensional reinforcing fabric therein.

While the invention is illustrated and may be described in connection with a preferred embodiment, it will be understood that it is in no way intended to limit the invention to that embodiment. On the contrary, it is intended to cover all alternatives, modifications and equivalents as may be included within the true spirit and scope of the invention as limited only by the appended claims.

### DETAILED DESCRIPTION

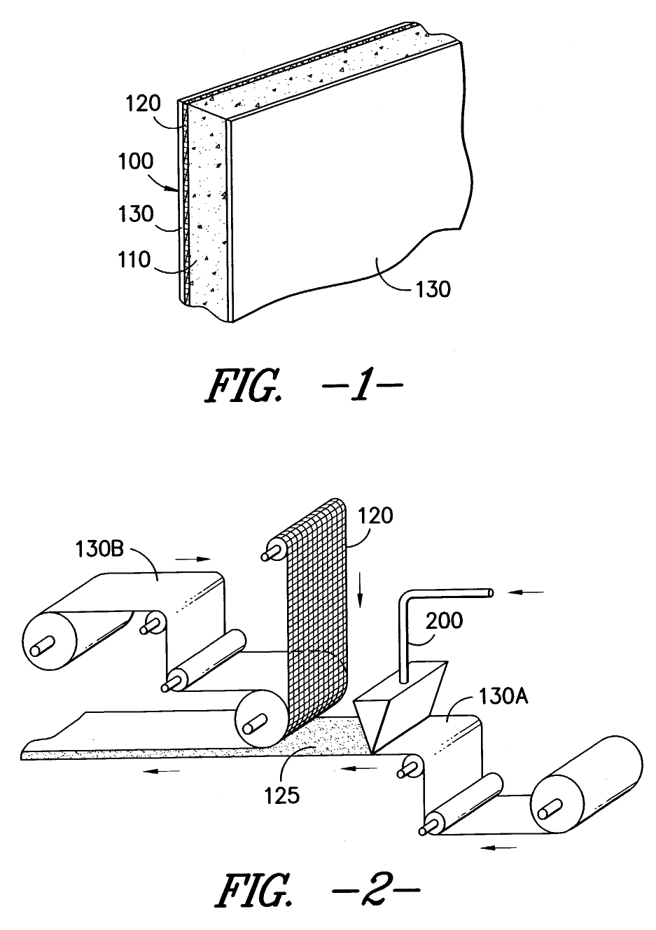

The new and improved textile reinforced gypsum wallboard 100 is shown in FIG. 1.

The Core

The core 110 comprises, in a preferred embodiment, gypsum, diethylene triamine tetra acetic acid, calcium naphthalene sulphonate, acid modified wheat starch, chopped fiberglass, foam, and raw vermiculite ore. The diethylene triamine tetra acetic acid serves as a stucco set-time retardant, while the calcium naphthalene sulphonate is a water reducing agent. The chopped fiberglass, which helps to reinforce the core and provide additional fire resistance properties, is preferably a ½″ M 190 product from Johns Manville, sold under the trade name CHOP-PAK. The raw vermiculite ore is commonly used for fire rated (fire resistant) wallboards. It should be understood that while this core formulation is a particularly useful embodiment, many other core formulations would be suitable for use within the context of the wallboard disclosed herein. Optional components may also be used, when necessary, such as water repellent compounds, fire resistant compounds, set accelerators, retarders, foaming agents, dispersing agents, pulp fiber, and other suitable or desirable components. Alternatively, the core may comprise Portland cement, plaster, stucco and any combination thereof.

In commercial construction, a drywall system commonly requires a certain level of fire resistance. A typical example is a foot traffic corridor in a commercial building, which also serves as a means of egress in case of a fire. It is common practice to enhance the fire resistance of gypsum plasterboard by incorporating an even distribution of chopped fiber strands within the core gypsum matrix. During exposure to elevated temperatures gypsum plasterboard dehydrates and shrinks. Unreinforced plasterboard usually develops large isolated cracks after a relatively short period of fire exposure. An even distribution of glass fibers controls the pattern of shrinkage cracks and provides tensile strength when the face paper burns away, significantly enhancing the fire resistance. Fibers also result in better sheet integrity, which is especially important near the fasteners at the board edges to prevent premature fall of linings under exposure to fire.

Two boards were tested for fire resistance in accordance with Australian Standard AS 1530. The Standard Plasterboard contains no chopped glass fibers, but the Fire Resistant Plasterboard does. Results are as follows:

13 mm Standard Plasterboard achieves a fire resistance of 32 minutes on a metal stud frame.

13 mm Fire Resistant Plasterboard achieves a fire resistance of 63 minutes on a metal stud frame

Although there are some other formulation differences such as plasterboard density and the addition of vermiculite that may contribute to the increased fire resistance rating, the main performance difference can be attributed to the addition of an even distribution of chopped glass fibre strands.

The Textile Reinforcement

The preferred textile reinforcement material 120 is a tri-directional fiberglass scrim material sold under the trade name STABILON® from Milliken & Company, based in Spartanburg, S.C., USA. The preferred scrim is a fiberglass material having a weight of 135 grams per square meter (gsm) and includes an acrylic coating. This material is identified as Milliken style number 930120. The warp is preferably 3,700 yard/lb. fiberglass yarn with an approximate density of ten yarns per inch. The cross machine direction yarns are preferably 1,800 yard/lb. fiberglass yarns. These yarns are inserted at a density of 2.7 yarns per inch at both 45 degrees and 135 degrees. The total cross machine yarn density is approximately 5.4 yarns per inch. These yarns are commercially available from Advanced Glassfiber Yarns in Aiken, S.C. or PPG Industries in Pittsburgh, Pa. Other suitable reinforcing textiles include a lighter bi-directional fiberglass scrim from Saint Gobain Technical Fabrics, which has a weight of 36 gsm. The Saint Gobain material is identified as Saint Gobain style number GDF4410/A. It is constructed of 7,500 yard/lb. fiberglass yarns with a density of four yarns per inch. The cross machine direction yarns are 3,700 yard/lb. fiberglass yarns inserted perpendicular to the machine direction yarns at a rate of four yarns per inch. The yarns are bonded with polyvinyl alcohol adhesive. Another alternative is a fiberglass scrim manufactured by Winstone Wallboards, Ltd. under the trade name DUROID, having a weight of 36 gsm, and is of a generally similar construction to the Saint Gobain material. Generally, the weight range of reinforcing textiles will fall between 0.5 oz/square yard (17 gsm) and 16 oz/square yard (543 gsm), and most preferably between 1.0 oz/square yard (34 gsm) and 6 oz/square yard (204 gsm). Other types of scrim materials including bi-directional (square or diamond) configurations may be used, and the weight of such materials may be varied, depending on the amount of strength required for the particular wallboard application. Such scrim fabrics may, in alternative embodiments, be woven, knit, non-woven, laid scrim, or may be extruded. Alternative reinforcing textiles may be made from base materials other than fiberglass, such as plastics, so long as they may be sufficiently adhered to the wallboard core, and so long as they provide sufficient tensile strength for reinforcement. Such alternative reinforcing materials include scrim or fabric made from carbon fibers, aramids (including meta-aramids such as Nomex® from DuPont and para-aramids such as KEVLAR®), and BASOFIL® manufactured by BASF Corporation. For fire resistant applications, scrims or fabrics made from fire resistant fibers having a high melting point may be used, including mineral fibers, rock wool, mineral wool, basalt and vermiculite.

Fiberglass is the preferred material used for the textile reinforcement because it is inexpensive to manufacture and process, it may be easily cut in line at the wallboard manufacturing plant, it survives the high temperatures in the manufacturing plant, it may be easily scored and snapped by workers on a construction site, and it is inherently fire resistant. Further, fiberglass has a Young's modulus rating similar to that of the wallboard core, which allows for the glass yarns to break under roughly the same stress as the breaking point of the wallboard core.

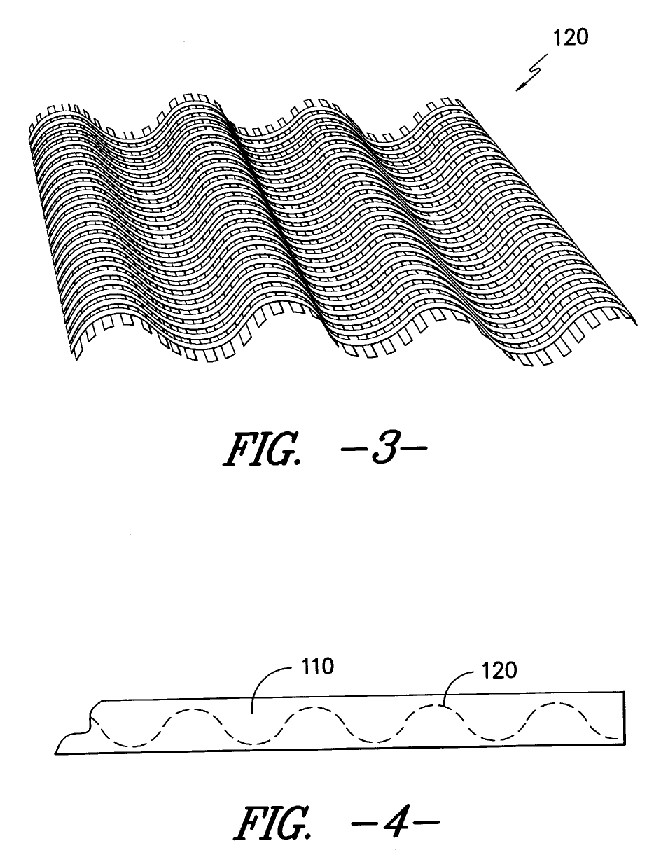

In an alternate embodiment, the reinforcing scrim 120 may be formed into a three-dimensional wave structure, one example of which is shown in FIG. 3. FIG. 4 shows the three-dimensional structure of FIG. 3 as it is incorporated into a wallboard. Such a structure provides dimensional stability in three dimensions, rather than two dimensions. In one preferred embodiment, the reinforcing scrim is formed in a three-dimensional configuration so that the peaks and valleys of the structure run in a longitudinal direction of the wallboard. Other potentially preferred embodiments include wallboards where the reinforcing scrim is formed into a three-dimensional structure so that each peak and valley of the structure runs in a transverse direction, or alternatively in a bias direction, with respect to the wallboard. The fabric may be formed into a three dimensional shape during the board formation process, where a flat reinforcing fabric is shaped into the three-dimensional structure as it is fed into the slurry. One method of forming the reinforcing scrim or fabric into a three-dimensional shape is to run the fabric over a mold having the desired three-dimensional shape, and to simultaneously apply a resin to the fabric in order to hold the desired shape. Although the three-dimensional fabric is shown herein as being in a repeating U or sine wave shape, it is contemplated that any desired or suitable three-dimensional shape may be used, such as a repeating V shape or a square wave shape.

Alternatively, other reinforcing structures may be used, including Tensar®, which is a plastic mesh web manufactured by Netlon Limited Company of the United Kingdom, thermoplastic nonwovens such as a polyester needlepunched mat, or Colbond products such as the ARMATER® honeycomb-type geocomposite, ENKAGRID® geogrid, or the ENKAMAT® three-dimensional polymer matting. Suitable reinforcing structures will be characterized by sufficient porosity to allow moisture to escape, relatively high adhesive strength to gypsum, sufficient tensile strength to improve flexural strength and/or impact resistance, and will be lightweight.

The Paper

In a preferred embodiment, the paper 130 used on the face of the wallboard is Ivory Face Paper having a weight of 190 gsm, while the preferred paper for the back of the wallboard is Brown Back Paper, having a weight of 190 gsm. Preferably, the paper should have a weight range between 150 gsm and 450 gsm, and more preferably between 170 gsm and 300 gsm. These face and back papers are commercially available from VISY PAPER Pty. Ltd. of Australia.

The Adhesive

It has been found that the use of non-water-soluble adhesives, and more specifically acrylic adhesives, when used to bind the reinforcing textile together and to bind the reinforcing textile to the wallboard core, have shown surprising results in bending strength testing, as shown in the examples and tables below. The preferred acrylic adhesive is Noveon's MW 3145. This is a cross-linking acrylic co-polymer suitable for bonding textile yarns in a laid scrim operation. This chemical is available through Noveon of Gastonia, N.C.

### EXAMPLE 1

Below is one example of a wallboard formed in accordance with one aspect of the present invention.

| | | | | | | | |
|---|---|---|---|---|---|---|---|
| BOARD | 1.2 | M | | | | | |
| WIDTH | | | | | | | |
| BOARD | 13 | Mm | | | | | |
| THICKNESS | | | | | | | |
| IVORY FACE | 0.1979 | Width | 1250 | mm | Weight | 190 | gsm |
| PAPER | | | | | | | |
| KG/M2 | | | | | | | |
| BROWN | 0.1876 | Width | 1185 | mm | Weight | 190 | gsm |
| BACK | | | | | | | |
| PAPER | | | | | | | |
| KG/M2 | | | | | | | |

| | | |
|---|---|---|
| Total Paper KG/M2 | 0.3855 | |
| TOTAL PAPER | 0.6000 | |
| THICKNESS mm | | |
| GYPSUM KG/M2 | 10.2109 | |
| FIBERGLASS | 0.0360 | Saint Gobain GDF 4410/A - |
| SCRIMKG/M2 | | 35.7 gsm, PVOH coating |
| DPTA (TRILON C) | 0.0030 | Diethylene Triamine Tetra |
| KG/M2 | | Acetic Acid - Plaster retarder |
| DURASAR | 0.0126 | Ca Naphthalene Sulphonate - |
| KG/M2 | | Water reducing agent |
| STARCH KG/M2 | 0.0500 | Acid modified wheat starch |
| CHOPPED | 0.0300 | ½″ M 190 Johns Manville |
| FIBERGLASS | | CHOP-PAK |
| KG/M2 | | |
| FOAM KG/M2 | 0.0020 | |
| VERMICULITE | 0.4600 | |
| KG/M2 | | |
| Total minor | 0.5936 | |
| Ingredients | | |
| BOARD WEIGHT | 11.1900 | |
| KG/M2 | | |
| WATER/STUCCO | 0.82 | |
| RATIO | | |

Manufacturing Method

Gypsum plasterboard (wallboard) is conventionally manufactured by enclosing a core containing an aqueous slurry of calcined gypsum (stucco or calcium sulphate hemihydrate) between two sheets of paper. The slurry may contain other additives, such as chopped glass fibers, vermiculite, and other suitable or desirable additives, as discussed previously. Stucco is typically manufactured by drying, grinding and calcining gypsum rock to produce the stucco (calcined gypsum). The calcination reaction is described by the following equation:

CaSO₄.2H₂O+heat [symbol] CaSO₄.½H₂O+1½H₂O

The ‘setting’ reaction is the reverse of the above calcination reaction and involves a reaction of the stucco when mixed with water. The theoretical water content of the stucco slurry required for full reaction of high purity stucco is approximately 19%. The slurry then relatively quickly sets or hardens into a gypsum mass.

Commercial manufacturing of gypsum wallboard typically occurs under continuous high-speed conditions wherein the stucco and other ingredients are continuously mixed with warm water, and the resulting slurry 125 is continuously deposited onto a first continuously fed sheet of paper 130A using slurry depositing mechanism 200, as shown in FIG. 2. The temperature of the stucco slurry is preferably controlled at between 35° C. and 40° C. to improve core strength and accelerate the stucco hydration process. More preferably the slurry temperature is between 37° C. and 39° C. Excess water is incorporated into the slurry to improve fluidity and allow the slurry to flow across nearly the full width of the first sheet of paper. Typically the water-to-stucco mixing ratio is about 60 to about 75-weight parts water per 100-weight parts stucco.

In one potentially preferred embodiment, a coated fiberglass reinforcing scrim 120 is continuously fed so that the scrim is placed and set on top of the slurry 125. It has been found that a high water resistant coating applied to fiberglass reinforcing scrim results in enhanced soft and hard body impact performance. High water resistant coating binders may include but are not limited to polyvinyl acetate, polyvinyl acetate and acrylic copolymers, styrene acrylic, styrene butadiene and acrylic. Conversely, a low water resistant coating applied to an identical fiberglass reinforcing scrim has significantly lower soft and hard body impact resistant performance. Low water resistant coating binders may include but are not limited to polyvinyl alcohol or starch. When samples of a polyvinyl acetate and acrylic co-polymer coated scrim were immersed in water maintained at a temperature of 45° C. for 13.5 minutes, the water absorbed as measured by weight gained was about 13%. When the same scrim was immersed in water maintained at 45° C. for 20 minutes the water absorbed was about 15%. The scrim retained its weave and shape through both of these tests. However, when a scrim of identical makeup, but coated with a polyvinyl alcohol, was tested in an identical manner, the binder dissolved within about one minute and the bundles of reinforcing fibers in the scrim separated without agitation. Thus, it was not possible to assess the moisture uptake of the binder because it rapidly dissolved in warm water.

In one potentially preferred embodiment, a second continuously fed sheet of paper 130B is applied onto the top of the stucco slurry 125 and the reinforcing scrim 120, resulting in a full encasement of the reinforcement and wallboard core. However, it is contemplated herein that the reinforcing scrim could be used without the second continuously fed sheet of paper.

This composite is supported on a continuous smooth rubber type belt (not shown) while the stucco sets through the hydration process. The setting reaction produces gypsum crystals, which form and grow into the internal or bonding ply of the paper lining, resulting in a strong bond between the gypsum wallboard core and the paper lining. The continuously formed composite mass moves along the forming belt and over the supporting rollers in a controlled manner to allow for a time period sufficient for the gypsum wallboard core to set hard enough to be cleanly cut into sheets of predetermined length. Typically this period is about 3 minutes to about 15 minutes depending on core ingredients, formulation, wallboard weight and wallboard thickness. Generally, a high-density 13 mm gypsum wallboard requires about 13 minutes setting time prior to cutting. Typically wallboard manufacturers use knives with four or five teeth per inch to cut gypsum wallboard. However, it has been found that the use of knives with nine or ten teeth per inch results in a cleaner cutting or severing of the reinforcing scrim and the wallboard. The cut sheets of wallboard are fed into a dryer to remove any remaining surplus moisture.

Flexural Test

Table 1, titled “Flexural Testing” is a detailed explanation of the gypsum panels produced and the corresponding flexural test results. The first three columns of the table contain the description of the reinforcement and the last three columns of the table are a summary of the test results. Sample 1 is a control without fabric reinforcement. Samples 2, 3, and 4 are boards identical to the control sample with different reinforcing fabrics added to the core. Sample 2 is a bi-directional laid scrim with a weight of 36 gsm. The bonding adhesive of this sample is polyvinyl alcohol. Samples 3 and 4 are 135 gsm Stabilon® tri-directional fiberglass fabrics from Milliken & Company. Sample 3 has traditional polyvinyl alcohol and Sample 4 has the cross-linked acrylic co-polymer adhesive MW-3145.

TABLE 1
FLEXURAL TESTING

| | Scrim | | | | Improvement |
|---|---|---|---|---|---|
| Sample Identification and | Weight | | Test | MOR | over control |
| Description | (gsm) | Adhesive | Direction | (MPa) | (%) |
| 1. Control (no scrim) | — | — | para | 7.06 | Control |
| | | | perp | 3.44 | Control |
| 2. Saint Gobain Technical | 36 | Polyvinyl alcohol | Para | 8.33 | 18 |
| Fabrics bi-directional | | | Perp | 5.30 | 54 |
| 3. Milliken tri-directional | 135 | Polyvinyl alcohol | Para | 12.60 | 78 |
| fiberglass scrim | | | perp | 5.71 | 66 |
| 4. Milliken tri-directional | 135 | Cross-linked acrylic | para | 14.12 | 100 |
| fiberglass scrim | | co-polymer | perp | 11.27 | 227 |

All of the samples were tested for flexural strength according to AS/NZS 2588:1988 on 100 mm wide samples with approximate beam length of 356 mm. The rate of loading was 25 mm/minute. The results are reported for the “face-up” specimens representing the effect of the different reinforcing materials in column 5 of Table 1. Samples 1 through 4 were tested in both the parallel and perpendicular machine directions. The results show fiberglass reinforced cores combined with fabrics are greatly more effective than the control groups. Comparing Sample 3 to Sample 2 shows the improved efficiency of fabric weight. Samples 3 and 4 can be compared to see the effect the fabric coating has on the wallboard. The results show a clear improvement in the peak load required to break the panel with the substitution of the polyvinyl alcohol with a cross-linked acrylic co-polymer adhesive.

Hard Body Impact Tests

Hard body impact tests were performed on several different wallboards in accordance with a draft ASTM Standard entitled “Standard Specification for Abuse Resistance Interior Panels” dated Sep. 11, 2002. Generic descriptions of the boards tested are given in Table 2. Average measured board densities and thicknesses are given in Table 3.

TABLE 2
Generic Description of Boards Tested.

| | Scrim incorporated near |
|---|---|
| Board Label | back face of GIB Toughline board |
| Duroid | Duroid scrim |
| Saint Gobain | Saint Gobain scrim |
| Miliken PVOH | Miliken fabric 135 gsm # 930120 451 - PVOH |
| | coating scrim |
| Miliken Acrylic | Milliken fabric 135 gsm # 930120 450 - Acrylic |
| | coating scrim |
| Unreinforced | Non fabric reinforced wallboard core |

Observations and Results

A summary of the maximum drop height resisted before the board was decreed to have failed is given in Table 3. What constitutes failure has been taken to be a complete penetration of the hammer through the sheets.

Specimen 1 of Saint Gobain and Duroid and Specimen 1 and 2 of the Milliken PVOH were subjected to multi-impacts at the same location. This was to develop the impact levels for subsequent tests. Failure for both Saint Gobain and Duroid resulted from an impact with a 350 mm C.O.M. drop at the same location as a 300 mm C.O.M. 15 drop impact had already occurred. (C.O.M. means center of mass).

TABLE 3
Summary of Maximum Drop Height Resisted Without “Failure”
(Failure is defined to be a complete penetration
of the impact hammer head)

| Board | Thickness | Density | Maximum C.O.M. |
|---|---|---|---|
| Label | (mm) | kg/m³ | Drop Height (mm) |
| Unreinforced | 13.04 | 869 | 150 |
| Saint Gobain | 12.72 | 886 | 300 |
| Duroid | 12.87 | 851 | 300 |
| Miliken PVOH | 13.01 | 834 | 350 |
| Miliken Acrylic | 12.84 | 858 | 450 |

Thus, it can be seen that the combination between chopped glass fibers incorporated into a gypsum wallboard core and a reinforcing scrim embedded therein has resulted in a novel wallboard structure having superior strength characteristics without sacrificing fire resistance.

Although the present invention has been described in considerable detail with reference to certain preferred versions thereof, other versions are possible. Therefore, the spirit and scope of the appended claims should not be limited to the description of the preferred versions contained herein.

What is claimed is:

1. A reinforced wallboard comprising:
a core material including chopped glass fibers; and
at least one layer of a textile reinforcement embedded within said core.

2. The reinforced wallboard set forth in claim 1, further including at least one layer of paper disposed on a first side of said wallboard.

3. The reinforced wallboard set forth in claim 2, further including a second layer of paper disposed on an opposed side from said first layer of paper.

4. The reinforced wallboard set forth in claim 1, wherein said textile reinforcement is selected from the group consisting of tri-directional fiberglass laid scrim material or bi-directional fiberglass laid scrim material.

5. The reinforced wallboard set forth in claim 2, wherein said textile reinforcement material is disposed adjacent said first layer of paper.

6. The reinforced wallboard set forth in claim 1, wherein said textile reinforcement is a scrim material having a weight in the range of about 17 gsm and about 543 gsm.

7. The reinforced wallboard set forth in claim 1, wherein said textile reinforcement is adhered together by means of a non-water soluble adhesive.

8. The reinforced wallboard set forth in claim 7, wherein said adhesive is an acrylic adhesive.

9. The reinforced wallboard set forth in claim 1, wherein said core is selected from the group consisting of gypsum, Portland cement, plaster, stucco and any combination thereof.

10. The reinforced wallboard set forth in claim 1, wherein said wallboard has a weight in the range between about 1000 and 5000 pounds/1000 sq. feet.

11. The reinforced wallboard set forth in claim 1, wherein said wallboard has a density in the range between about 25 and about 100 pounds per cubic foot.

12. The reinforced wallboard set forth in claim 1, wherein said textile reinforcement is made from continuous fiberglass strands.

13. The reinforced wallboard set forth in claim 1, wherein said textile reinforcement is disposed adjacent a face or back of said wallboard.

13. The reinforced wallboard set forth in claim 12, further including a second textile reinforcement adjacent an opposed side of said wallboard.

14. The reinforced wallboard set forth in claim 1, wherein said textile reinforcement is formed into a three-dimensional wave shape.

15. The reinforced wallboard set forth in claim 14, wherein said three-dimensional wave shaped textile reinforcement is oriented within said wallboard so that each peak and valley of said wave shaped textile reinforcement runs in a longitudinal direction with respect to said wallboard.

16. The reinforced wallboard set forth in claim 14, wherein said three-dimensional wave shaped textile reinforcement is oriented within said wallboard so that each peak and valley of said wave shaped textile reinforcement runs in a transverse direction with respect to said wallboard.

17. The reinforced wallboard set forth in claim 14, wherein said three-dimensional wave shaped textile reinforcement is oriented within said wallboard so that each peak and valley of said wave shaped textile reinforcement runs in a bias direction with respect to said wallboard.

18. A method for producing a reinforced wallboard, said method comprising the steps of:
providing a continuous feed of a first layer of paper
providing a continuous feed of a core slurry to spread over said first layer of paper, wherein said core slurry includes chopped glass fibers;
providing a continuous feed of a reinforcement material;
providing a continuous feed of a second layer of paper;
bringing said layers of paper, said core slurry and said reinforcement together; and
allowing said core slurry to set between said layers of paper with said textile reinforcement being disposed adjacent said second layer of paper.

19. The method set forth in claim 18, further including the step of turning up the sides of said first layer of paper so as to form a trough in which the core slurry can be accommodated.

20. The method set forth in claim 18, further including the step of heating the wallboard to facilitate the setting of the core material.

21. The method set forth in claim 18, further including the step of applying adhesive to said reinforcement.

22. The method set forth in claim 21, wherein said adhesive is a non-water soluble adhesive.

23. The method set forth in claim 22, wherein said non-water soluble adhesive is an acrylic adhesive.

24. The method set forth in claim 18, including the step of forming said reinforcement material into a three-dimensional wave shape.

25. The method set forth in claim 18, wherein said reinforcing material is a textile material.

26. The method set forth in claim 25, wherein said textile reinforcing material is a fiberglass laid scrim.

27. The method set forth in claim 26, wherein said fiberglass laid scrim is a tri-directional scrim.

28. A textile reinforcement for wallboards comprising:
a fiberglass laid scrim; and
a non-water soluble adhesive applied to said scrim.

29. The textile reinforcement set forth in claim 28, wherein said non-water soluble adhesive is an acrylic adhesive.

30. The textile reinforcement for wallboards set forth in claim 28, wherein said fiberglass laid scrim is a tri-directional scrim.

31. The textile reinforcement for wallboards set forth in claim 28, wherein said fiberglass laid scrim is a bi-directional scrim.

32. The textile reinforcement for wallboards set forth in claim 28, wherein said fiberglass laid scrim has a weight in the range of 17 gsm and 543 gsm.

33. A reinforced wallboard comprising:
a gypsum core;
a textile reinforcement at least partially embedded within said core; and
wherein a single layer ½ inch thickness of said reinforced wallboard installed on each side of a metal stud frame exhibits a fire resistance of at least 60 minutes when said wallboard is tested in accordance with Australian Standard AS 1530 fire resistance test.

34. The reinforced wallboard set forth in claim 33, further including at least one layer of paper disposed on a first side of said wallboard.

35. The reinforced wallboard set forth in claim 34, further including a second layer of paper disposed on an opposed side from said first layer of paper.

36. The reinforced wallboard set forth in claim 1, wherein said textile reinforcement is selected from the group consisting of tri-directional fiberglass laid scrim material or bi-directional fiberglass laid scrim material.

37. The reinforced wallboard set forth in claim 34, wherein said textile reinforcement material is disposed adjacent said first layer of paper.

38. The reinforced wallboard set forth in claim 33, wherein said textile reinforcement is a scrim material having a weight in the range of about 17 gsm and about 543 gsm.

39. The reinforced wallboard set forth in claim 33, wherein said textile reinforcement is adhered together and to the core by means of a non-water soluble adhesive.

40. The reinforced wallboard set forth in claim 39, wherein said adhesive is an acrylic adhesive.

41. The reinforced wallboard set forth in claim 33, wherein said core density is between the ranges of 25 and 100 pounds per cubic foot.

42. The reinforced wallboard set forth in claim 33, wherein said textile reinforcement is made from continuous fiberglass strands.

43. The reinforced wallboard set forth in claim 33, wherein said textile reinforcement is disposed adjacent a first side of said wallboard.

44. The reinforced wallboard set forth in claim 43, further including a second textile reinforcement adjacent a second side of said wallboard.

45. The reinforced wallboard set forth in claim 33, wherein said textile reinforcement is formed into a three-dimensional wave shape.

46. The reinforced wallboard set forth in claim 45, wherein said three-dimensional wave shaped textile reinforcement is oriented within said wallboard so that each peak and valley of said wave shaped textile reinforcement runs in a longitudinal direction with respect to said wallboard.

47. The reinforced wallboard set forth in claim 45, wherein said three-dimensional wave shaped textile reinforcement is oriented within said wallboard so that each peak and valley of said wave shaped textile reinforcement runs in a transverse direction with respect to said wallboard.

48. The reinforced wallboard set forth in claim 45, wherein said three-dimensional wave shaped textile reinforcement is oriented within said wallboard so that each peak and valley of said wave shaped textile reinforcement runs in a bias direction with respect to said wallboard.
